(19) United States
(12) Patent Application Publication
(10) Pub. No.: US 2024/0075325 A1
(43) Pub. Date: Mar. 7, 2024

(54) MULTI-LAYER FLEXIBLE FIRE BARRIER

(71) Applicants: Seamus DEVLIN, County Cork Clonakilty (IE); Tracey DEVLIN, County Cork Clonakilty (IE)

(72) Inventors: Seamus DEVLIN, County Cork Clonakilty (IE); Tracey DEVLIN, County Cork Clonakilty (IE)

(21) Appl. No.: 18/272,450

(22) PCT Filed: Oct. 27, 2021
(86) PCT No.: PCT/EP2021/079843

§ 371 Date: Jul. 14, 2023

(30) Foreign Application Priority Data
Jan. 15, 2021 (GB) 2100499.9

(51) Int. Cl. A62C 2/06; A62C 2/10

(52) U.S. Cl. CPC A62C 2/065; A62C 2/10

(57) ABSTRACT

A fire resistant barrier comprising two corrugated retaining layers, a layer of aerogel, and a layer of intumescent, wherein the layer of aerogel and the layer of intumescent are between the two corrugated retaining layers.

### TECHNICAL FIELD

The present invention relates to a fire resistant barrier or curtain.

### BACKGROUND AND PRIOR ART

There is an ongoing need to protect structures and people resident and working within those structures from the spread of heat, flames and toxic smoke arising from a fire within the structure. This is particularly crucial where zones are created to isolate fire and prevent its progression within the structure and various types of fire curtains and fire screens have been developed with this purpose in mind.

A fire curtain is used where, if there is a fire, it is necessary to create a temporary barrier within an opening, which seals off the area from fire. The curtain descends and prevents any fire and smoke from spreading from one area to another. It also allows people access to protected escape routes without any loss of fire resistance.

A typical fire and smoke protective curtain/barrier assembly comprises a flexible heat-resistant fabric impregnated with a coating to limit air infiltration and concealed in a head box, which is installed and located near or within the ceiling. On receiving a signal from a fire-detection device, the curtain is automatically deployed. The curtain unfurls from the head box, thereby separating one area from another. While not 100 percent fail-safe, fire curtains also deploy via gravity on loss of power. The bottom of the curtain can be weighted to assist with deployment and limit deflection caused by air movement.

Currently, fire and smoke protective curtains provide non-structural separation only and are not intended to be substituted for structural hourly-rated partitions or opening protectives that have been tested for fire endurance and hose stream performance. A major limitation of current fire-protective curtain technology is that they are a stopgap intended to provide supplemental, passive fire protection as part of an engineered fire protection system rather than a full fire-resistive building element, component or assembly.

The differences in the test criteria may be exemplified with reference to current United States ASTM E 119 ‘Standard Test Method for Fire Tests of Building Construction and Materials’ and ANSI/UL 10D ‘Standard for Fire Tests of Fire-Protective Curtain Assemblies’. The difference in these fire tests illustrate the limitations of current fire curtain technologies to meet the full range of threats presented by fire within a structure.

ASTM E 119 is used to evaluating fire-resistive building elements, components, and assemblies and prescribes a standard fire exposure controlled by the test facility to meet specified temperatures during a specified time. On completion of the fire endurance test, the assembly is subjected to the impact, erosion, and cooling effects of a hose stream of water. These test standards require temperatures to be recorded on the curtain unexposed surface.

As fire and smoke protective curtains are thermally thin, they cannot meet the temperature limits established by ASTM E 119 on the unexposed surface, even though they are subjected to the standard time-temperature curve defined within ASTM E 119. As a result, ANSI/UL 10D does not require the products to limit temperature on the unexposed surface.

Similarly, it is also virtually impossible for the current generation of fire and smoke protective curtain assemblies to withstand effects of the hose stream test on completion of the fire endurance test. Hence under test standard ANSI/UL 10D the impact of the hose stream test after fire exposure is not required.

Therefore, fire and smoke protective curtains are not suitable as fire walls, fire barriers, fire partitions, smoke barriers for use in rated floors and ceilings denoted as horizontal assemblies and walls considered vertical assemblies as defined within the respective testing codes.

Various materials have been used to prevent the passage of flames, heat and toxic smoke including endothermic materials, insulating materials, intumescent materials as well as reflective materials and opacifiers.

A significant number of patents describe varying methods and materials used to prevent the passage of flames, heat and toxic smoke from one part of a structure to another. U.S. Pat. No. 8,663,774 B2 describes the formation of various forms of multi-layer thermal insulation composites comprising permutations of fibrous insulation layers, super-insulation layers, inorganic heat absorbing layers and encapsulating scrims to form substantially flat sheets of stacked layers which offer improved resistance to the spread of heat, flames and toxic smoke arising from a fire within a structure.

One of the illustrative embodiments described within U.S. Pat. No. 8,663,774 describes a multi-layer thermal composite comprising at least one inorganic heat absorbing layer and at least one super-insulation layer adjacent at least one side of the inorganic heat absorbing layer wherein the inorganic heat absorbing layer may comprise at least one of an endothermic layer or intumescent layer. The super-insulation layer is further described as either an aerogel material which may be provided in the form of a flexible blanket or sheet or microfibre glass-based materials and microporous silica materials which are well known within the industry. U.S. Pat. No. 8,663,774 describes that this multi-layered thermal composite is produced in flat sheets wherein the layers may optionally be fixed to with at least one of an adhesive, needle bonding or stitching. Further these layers may be partially or totally encapsulated in a protective scrim which may comprise a woven or non-woven material such as fibreglass, nylon or polyester mesh. It is noted that suitable scrim materials also include but are not limited to silica fibres, refractory ceramic fibres, mineral fibres or any other type of inorganic fire-resistant fibres.

Problems arise with the teachings described in U.S. Pat. No. 8,663,774 B2 where the inorganic heat absorbing material is an intumescent and the super-insulation layer is an aerogel material as these materials will not meet the requirements of ASTM E 119 in terms of passing the hose stream test. This hose stream test is conducted after the composite has been subjected to the fire test and after the intumescent has expanded forming an impact-fragile carbonaceous char.

Similarly, aerogels have an inherent friability and exhibit a lack of stability at temperatures in excess of 700° C. losing their porous structure and progressively failing. The prescribed ASTM E 119 time-temperature curve at 60 minutes is 927° C., 1010° C. at 120 minutes and 1093° C. at 240 minutes are all in excess of the rated values for aerogels.

In a further embodiment described in U.S. Pat. No. 8,663,774 B2 layers of intumescent and aerogel may be partially or totally encapsulated in a protective scrim which may comprise a woven or non-woven material such as fibreglass, nylon or polyester mesh. It is noted that suitable scrim materials also include but are not limited to silica fibres, refractory ceramic fibres, mineral fibres or any other type of inorganic fire-resistant fibres.

Fibreglass, nylon and polyester mesh cannot withstand the temperatures advised under ASTM E 119 and whereas silica fibres are formed wherein the effect of silica on the room-temperature properties of alumina fibres is to reduce their overall stiffness, and to increase their room-temperature strength by avoiding the formation of large grains. This results in flexible fibres which can be used in the form of woven cloths for thermal insulation. All these fibres have an external appearance similar to that of glass fibres however the presence of an amorphous silicate intergranular phase enhances creep which begins from 900° C. so that these fibres cannot be used for structural applications above this temperature. (Mineral and Ceramic Fibres—Boris Mahltig, Christopher Pastore, in Inorganic and Composite Fibres, 2018).

Refractory ceramic fibres can irritate the skin, eyes and upper respiratory tract but the main concern is that the individual fibres are small enough to penetrate deep into the lungs and possibly lead to the development of lung cancer and mesothelioma. On 10 Nov. 1997, a European Technical Progress Committee decided that the evidence was sufficient to warrant RCF being classified as a category 2 carcinogen (i.e. a substance to be regarded as if it were carcinogenic to humans) and the risk phase R49 (‘may cause cancer by inhalation’) would apply. Hence refractory ceramic fibres may not be used as scrim material.

With respect to U.S. Pat. No. 8,663,774 the numbers of layers of intumescent and aerogel could be increased such that should the device be encapsulated in a scrim the thickness of the composite is such that the unexposed face of the assembly never reaches the temperature limits ascribed to the scrim material. This increase in thickness represents increases in cost, weight and exacerbates problems with installation of the device.

Similarly U.S. Pat. No. 8,663,774 B2 advises that this scrim may optionally be fitted to the composite sheets with at least one of an adhesive, needle bonding or stitching said scrim where effective serving to inhibit the expansion of the intumescent layer or causing said scrim layer to detach, delaminate from the composite and associated fixings holding the device in situ.

Accordingly, there is a need to address the above outlined deficiencies of the prior art.

### SUMMARY OF THE INVENTION

The present teachings relate to a fire resistant barrier comprising two corrugated retaining layers, a layer of aerogel, and a layer of intumescent, wherein the layer of aerogel and the layer of intumescent are between the two corrugated retaining layers.

The fire resistant barrier may further comprise another layer of aerogel, wherein the layer of intumescent is held between the layers of aerogel.

The fire resistant barrier may further comprise another two layers of aerogel and another layer of intumescent wherein the layers of aerogel are interleaved with the layers of intumescent.

Optionally, the corrugated retaining layers comprise at least one of a stainless-steel foil, cardboard, and a waterproofing layer.

The corrugated retaining layers may be configured to maintain the shape of the layers of aerogel and intumescent.

The corrugated retaining layers may be configured to permit the fire resistant barrier to be folded and unfolded.

Optionally, the corrugated retaining layers are configured to allow space for the intumescent layer to expand when exposed to heat.

Optionally, under the influence of heat the intumescent layer is configured to form a hard carbonaceous char thereby creating an insulating layer.

The corrugated retaining layers may be configured to retain the carbonaceous char produced by the intumescent layer when exposed to heat.

The corrugated retaining layers may further comprise at least one of slits, slots or holes which allow the fire resistant barrier to collapse under compression and open under tension.

The first resistant barrier may further comprise a waterproof membrane encapsulated the layers of aerogel and intumescent.

Optionally, the waterproof membrane further encapsulates the corrugated retaining layers.

The present teachings may also relate to a fire resistant barrier comprising two folded layers of aerogel and a flat layer of intumescent encapsulated by the layers of aerogel, wherein the folded layers of aerogel are configured to accommodate expansion of the intumescent layer under the influence of heat.

Optionally, the aerogel layers are configured to unfold when the intumescent layer expands under the influence of heat.

### BRIEF DESCRIPTION OF THE DRAWINGS

FIG. 1 shows a possible configuration of the first resistant material in accordance with the present teachings;

FIG. 2 shows another possible configuration of the first resistant material in accordance with the present teachings;

FIG. 3 shows a further possible configuration of the first resistant material in accordance with the present teachings;

FIG. 4 shows another possible configuration of the first resistant material in accordance with the present teachings;

FIG. 5 shows one embodiment of the fire resistant barrier in accordance with the present teachings;

FIG. 6 shows the fire resistant barrier of FIG. 5 in a compressed or folded state;

FIG. 7 shows the fire resistant barrier of FIG. 5 in an expanded or unfolded state;

FIG. 8 shows also the fire resistant barrier of FIG. 5 in an expanded state to accommodate expansion of a layer of intumescent therein;

FIG. 9 shows another embodiment of the fire resistant barrier in accordance with the present teachings;

FIG. 10 shows a three-dimensional representation of the fire resistant barrier of FIG. 9; and

FIG. 11 shows the use of a waterproof membrane with the fire resistant barrier in accordance with the present teachings.

### DETAILED DESCRIPTION OF PREFERRED EMBODIMENTS

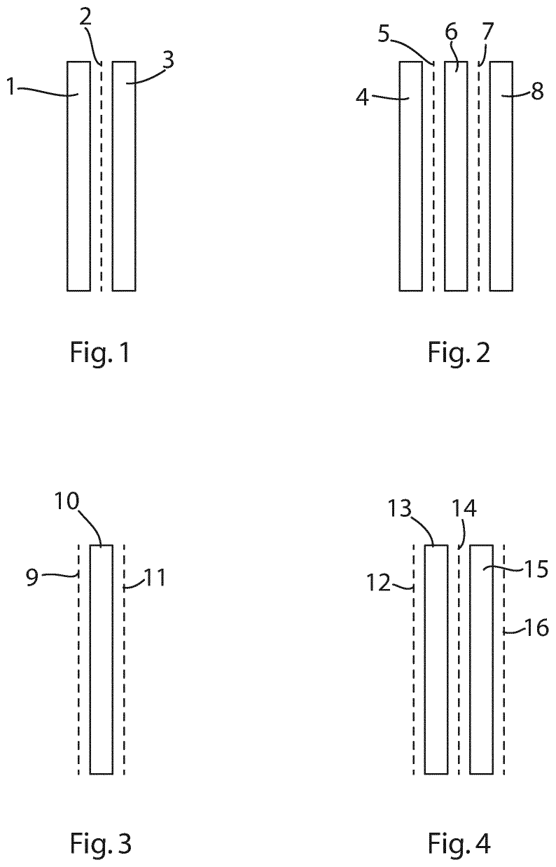

The present teachings provide a fire resistant barrier or curtain comprising a first resistant material. This fire resistant material comprises layers of intumescent material interspersed with layers of aerogel material. These layers can be formed in a multiplicity of configurations as shown in FIGS. 1 to 4.

FIG. 1 shows a first possible configuration of the first resistant material. The material includes an outer aerogel layer 1, at least one inner layer of intumescent 2 and a further outer layer of aerogel 3. The inner layer (or layers) 2 is in either sheet form or applied as coatings.

FIG. 2 shows a second possible configuration, which is a variation of FIG. 1. Layers of aerogel 4, 6 and 8 are interleaved with layers of intumescent 5 and 7 in either sheet form or applied as coatings.

FIG. 3 shows a further possible configuration where an outer layer of intumescent sheet or coating 9 is applied outside a layer of aerogel 10 with a further outer layer of intumescent 11 applied to the opposing face.

FIG. 4 shows another configuration, which is one possible variation of FIG. 3 where multiple layers of intumescent sheet or coatings 12, 14 and 16 are interspersed with aerogel layers 13 and 15.

FIGS. 1 to 4 do not represent all possible configurations of aerogel and intumescent but is merely representative of some possible layer configurations that could be used with the fire resistant barrier in accordance with the present teachings. It will be appreciated that the person skilled in the art may choose different layer configurations dependent on the requirements for a particular application of the fire recitation barrier. A single layer of intumescent and a single layer aerogel could also be used instead of the multiple layers described heretofore.

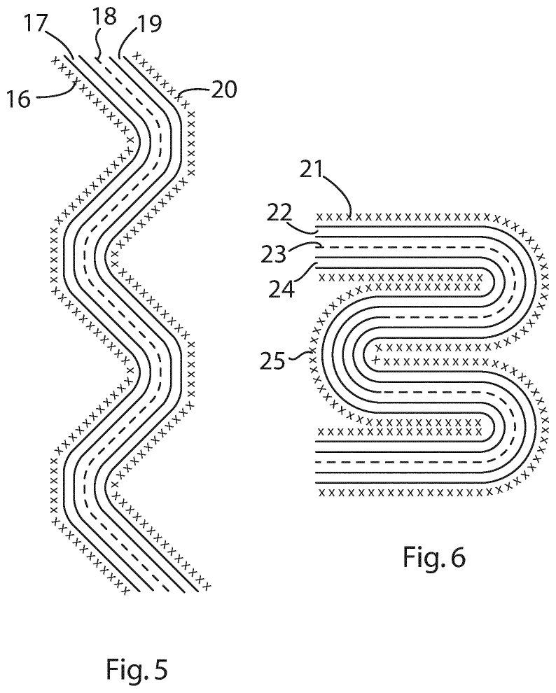

The intumescent and aerogel layers are held within a corrugated material such as shown in FIG. 5.

In particular, FIG. 5 shows the intumescent 18 and aerogel layers 17 and 19 held within two layers 16, 20 of a corrugated material. The corrugated material may be a stainless-steel foil, cardboard, a waterproofing layer or a combination of these. The corrugations permit the fire resistant barrier to be compressed and opened.

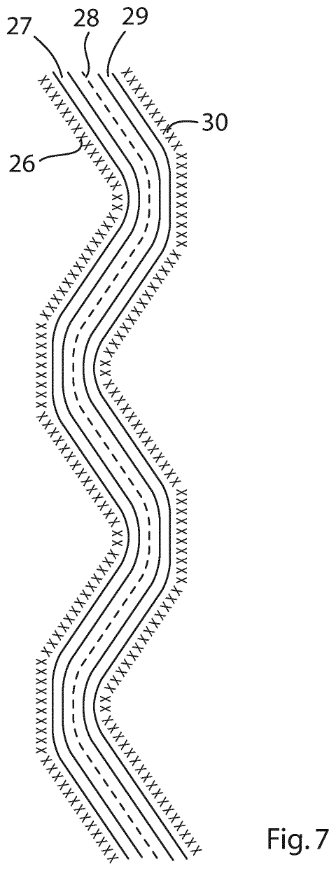

The corrugations permit the barrier to be compressed (or folded) as shown in FIG. 6 and expanded (or unfolded) as shown in FIG. 7. This allows the formation of an expandable curtain mechanism or bellows mechanism for fitting into an expansion gap which is subject to open and close in response to structural deflection.

As mentioned above, FIG. 6 this shows the fire resistant barrier compressed as it would be held within a magazine for deployment as a fire curtain or alternatively in its position should it have been installed within an expansion gap in a building where the said gap had closed due to deflections of the structure. When used as a fire curtain the barrier would be compressed as shown in FIG. 6 and upon release would unwind from a magazine container either under electrical power or by gravity. The bottom of the curtain can be weighted to assist with deployment and limit deflection caused by air movement. In this FIG. 6 an outer layer 21 of either stainless steel, cardboard or a waterproofing layer or a combination of all three elements would help encapsulate a layer of aerogel 22, a further layer of intumescent in either sheet form or as coatings 23 and further layer of aerogel 25. This provides a sandwich arrangement of layers held within a further layer 25 of either stainless steel, cardboard or a waterproofing layer or a combination of all three components.

In FIG. 7 the curtain or barrier is shown in a more extended configuration when compared to the configuration shown in FIG. 5. Such extension can arise in instances where the device has been installed within an expansion gap in a building wherein the said gap has opened due to deflection of the structure. Similarly, thermal convection currents during a fire may apply forces on the side facing the fire and this may cause extension of the device as shown. In these events the corrugated shape helps hold the carbonaceous char produced by the intumescent under the effect of heat in place.

In another embodiment the corrugated layers may be omitted. In this embodiment aerogel layers may be folded over flat layers of intumescent encapsulating said intumescent layers such that when intumescent layers expand under the influence of heat the aerogel layers unfold allowing the intumescent to expand without being constricted. That is, folds are introduced into the aerogel layers wherein these would unfold under the pressure exerted by the intumescent expanding. The aerogel performs the same function as the corrugated layers and would also hold the carbonaceous char produced by the intumescent under the effect of heat in place.

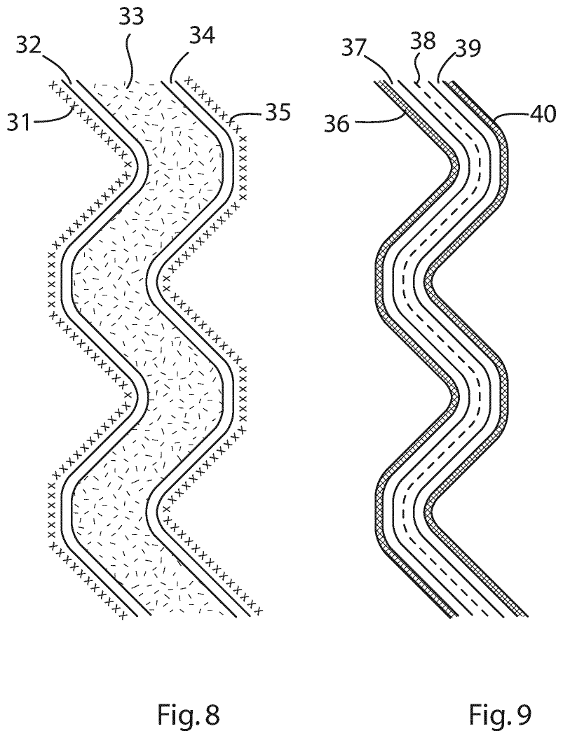

Turning to FIG. 8, it will be appreciated that the corrugated design shown in this figure allows space for the intumescent layer to expand without being constricted. As is known to the person skilled in the art, an intumescent is a substance that swells as a result of heat exposure. The barrier is often buffeted by thermal convection currents during a fire and the corrugated shape helps to hold the carbonaceous char produced by the intumescent under the effect of heat in place.

In particular, FIG. 8 illustrates the action of the intumescent layer 33 during a fire. Preferentially, this layer 33 comprises matrices of sodium silicates and/or graphite which can exert quantifiable expansion pressure and a volumetric expansion of several hundred times greater than its original volume. Under the influence of heat these intumescent materials form an expanding, hard carbonaceous char comprising layers of sodium silicate or graphite which inhibit the passage of heat through the construct thereby creating the swelling insulating layer 33.

Alternatively, compounds using ammonium polyphosphate, pentaerythritol and melamine may be used. These compounds produce a light char of microporous carbonaceous foam formed by chemical reaction within a molten binder typically based on vinyl acetate copolymers or styrene acrylates. They do not, however produce the same levels of volumetric expansion as that of sodium silicates or graphite.

It can be seen from FIG. 8 that this shows how the corrugated form of the device serves to provide space for the intumescent layer 33 to expand and under said expansion the layers of aerogel 32 and 34 as well as the corrugated layers 31 and 35) are forced outwards —stainless steel foil or cardboard, waterproofing (or a combination of all three components).

The corrugated layers of the barrier also serves to retain the carbonaceous char in position particularly when the barrier in installed in a vertical plane. As is known to those skilled in the art, intumescent (graphite) produces a ‘hard char’ which expands in reaction to temperature increase, this effect termed exfoliation increases the amount of insulation that a given passive fire barrier will exhibit.

As is also known to those skilled in the art, the greater the thickness of intumescent (graphite) layer=a greater exfoliation volume produced=a higher insulation level provided by the expanded intumescent. Therefore close control over the selection of the volumetric characteristics allied with thickness of the intumescing layer applied is important. This approach allows the fire resistant barrier in accordance with the present teachings to be accurately tailored to the fire rating required for a particular installation. For example, a project requiring 30 minutes resistance to fire could use a material with low volumetric expansion or a thinner layer of intumescent sheeting, whereas a differing project requiring 240 minutes fire protection could use materials or combinations thereof comprising intumescent sheeting with high volumetric expansion and/or thicknesses in single or multiples thereof. The intumescent (graphite) has to have the space to expand without threatening the integrity of the aerogel layer which is relatively inflexible. Accordingly, the corrugation allows for such expansion.

The corrugated material can be formed from a stainless-steel foil which is widely used in existing fire barriers used in expansion gaps where the stainless-steel foil resists penetration of the assembly during the hose stream test. The use of stainless steels as an encapsulant rather than a scrim made from woven or non-woven material such as fibreglass, nylon, polyester mesh, silica fibres, refractory ceramic fibres, mineral fibres or any other type of inorganic fire-resistant fibres is based the rated continuous service temperatures and melt temperatures of varying stainless-steel types. Stainless-steel 304 and 316-grades have rated continuous service temperatures of 925° C. and a melt temperature of 1400° C. 309-grade stainless steel has a continuous service temperature of 1095° C. and 310-grade can accommodate 1150° C. The prescribed ASTM E 119 time-temperature curve at 60 minutes is 927° C., 1010° C. at 120 minutes and 1093° C. at 240 minutes hence a 309 or 310-grade stainless-steel foil will not fail at test temperatures unlike the scrim equivalents noted in the above extract from U.S. Pat. No. 8,663,774 B2.

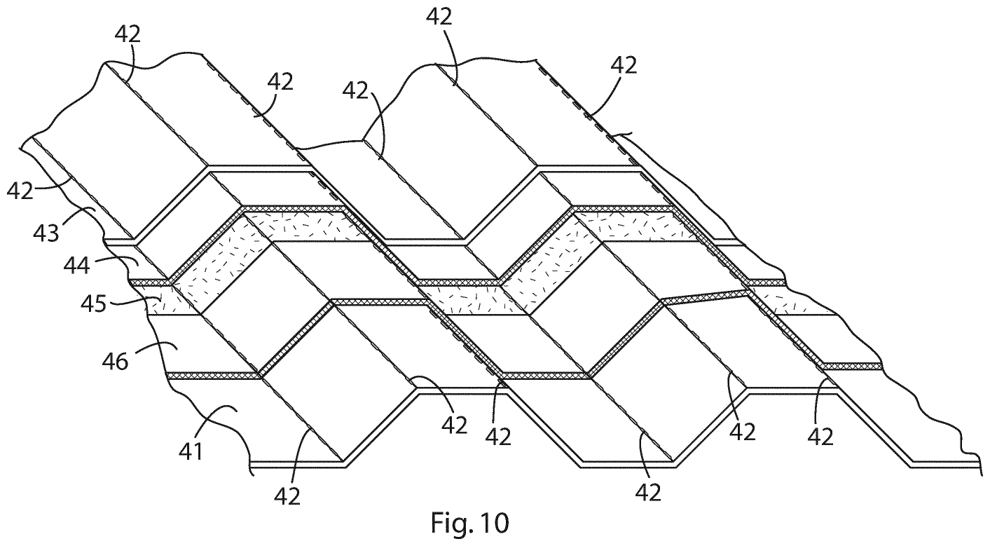

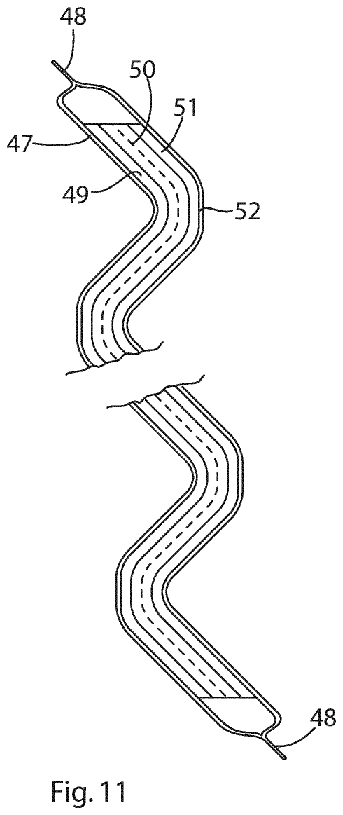

One alternative to the stainless-steel foil is cardboard retainer layers as displayed in FIG. 9 and FIG. 10 wherein the cardboard retainers incorporate slits, slots or holes at corners enabling the device to collapse under compression and open under tension. The cardboard retainer is principally used to retain the corrugated shape of the intumescent/aerogel composite and is sacrificial in the event of fire. Other materials such as corrugated plastic shapes may be used as an alternative to cardboard and stainless-steel foil.

In this further embodiment the composite intumescent layered system as shown in FIGS. 5, 6 and 7 may be held within a formed cardboard retainer as shown in FIGS. 9 and 10 which similarly collapses under compression and opens under tension. In particular, the exemplary embodiment of FIG. 9 shows the barrier with outer layers of cardboard 36 and 40 enclosing two layers of aerogel 37 and 38 and an inner layer of intumescent material 38.

FIG. 10 shows three-dimensional representation of the barrier described in FIG. 9 wherein a lower corrugated cardboard layer 41 supports a layer of aerogel 46 on top of which is an intumescent layer 45 topped by an upper layer of aerogel 44. An upper layer of corrugated cardboard 43 lies above the aerogel layer 44. Both layers of corrugated cardboard have slits, perforations or holes at points of flexure such that the device is capable of being extended or compressed as required.

In another embodiment shown as FIG. 11 the composite intumescent-aerogel layer may be encapsulated in a membrane which provides the fire resistant barrier or curtain in accordance with the present teachings with waterproofing capability. This waterproofing layer may encapsulate only the aerogel and intumescent layers or the complete barrier where it is fitted with the aforementioned outer corrugated layers (stainless steel and/or cardboard outer facings).

In particular, FIG. 11 shows the barrier encapsulated in a waterproofing membrane or coating 47 and 52 such that the aerogel layers 49 and 51, within which lies an intumescent layer 50, are completely enwrapped by the said waterproofing layer 47 and 52. Each end of the waterproofing layers 47 and 52 are sealed together 48.

It is clear from the above that the proposed invention represents a new generation of fire and smoke protective barriers of curtains which may be deployed in a similar manner to existing fire and smoke protective curtains whilst at the same time meeting fully the requirements of ASTM E 119 and thereby being suitable as a fire wall, fire barrier, smoke barrier for use in floors, ceilings and walls.

As noted, fire-resistant materials are used to create areas within structures which inhibit the spread of flame, heat and toxic smoke and/or form barriers to create escape routes allowing people to safely evacuate buildings in the event of fire. Voids, cavities and gaps within construction such as service penetrations and particularly expansion gaps which pass through floors, walls and ceilings can compromise the fire integrity of the structure. The proposed invention provides a solution to re-establishing the fire proofing integrity of such voids, cavities and gaps.

In particular, the present teachings provide a multi-layer thermal composite comprising at least one layer of intumescent and one layer of aerogel wherein such device lends itself to the formation of a fire curtain/barrier or be modified to re-establish the fire proofing integrity of voids, cavities and gaps created by service penetrations and expansion gaps.

The present teachings meet the requirements of ASTM E 119 ‘Standard Test Method for Fire Tests of Building Construction and Materials’ and when used in expansion gaps satisfy the test criteria established within ASTM E1399 ‘Standard Test Method for Cyclic Movement and Measuring the Minimum and Maximum Joint Widths of Architectural Joint Systems’ and UL 2079 ‘Standard for Tests for Fire Resistance of Building Joint Systems’.

The words comprises/comprising when used in this specification are to specify the presence of stated features, integers, steps or components but does not preclude the presence or addition of one or more other features, integers, steps, components or groups thereof.

1. A fire resistant barrier comprising:
two corrugated retaining layers;
a layer of aerogel; and
a layer of intumescent,
wherein the layer of aerogel and the layer of intumescent are between the two corrugated retaining layers.

2. The fire resistant barrier of claim 1 further comprising another layer of aerogel, wherein the layer of intumescent is held between the layers of aerogel.

3. The fire resistant barrier of claim 1 further comprising another two layers of aerogel and another layer of intumescent wherein the layers of aerogel are interleaved with the layers of intumescent.

4. The fire resistant barrier of claim 1 wherein the corrugated retaining layers comprise at least one of a stainless-steel foil, cardboard, and a waterproofing layer.

5. The fire resistant barrier of claim 1 wherein the corrugated retaining layers are configured to maintain the shape of the layers of aerogel and intumescent.

6. The fire resistant barrier of claim 1 wherein the corrugated retaining layers are configured to permit the fire resistant barrier to be folded and unfolded.

7. The fire resistant barrier of claim 1 wherein the corrugated retaining layers are configured to allow space for the intumescent layer to expand when exposed to heat.

8. The fire resistant barrier of claim 1 wherein under the influence of heat the intumescent layer is configured to form a hard carbonaceous char thereby creating an insulating layer.

9. The fire resistant barrier of claim 8 wherein the corrugated retaining layers are configured to retain the carbonaceous char produced by the intumescent layer when exposed to heat.

10. The fire resistant barrier of claim 1 wherein the corrugated retaining layers further comprise at least one of slits, slots or holes, which allow the fire resistant barrier to collapse under compression and open under tension.

11. The fire resistant barrier of claim 1 further comprising a waterproof membrane encapsulated encapsulating the layers of aerogel and intumescent.

12. The fire resistant barrier of claim 11 wherein the waterproof membrane further encapsulates the corrugated retaining layers.

13. A fire resistant barrier comprising:
two folded layers of aerogel; and
a flat layer of intumescent encapsulated by the two layers of aerogel;
wherein the two folded layers of aerogel are configured to accommodate expansion of the intumescent layer under the influence of heat.

14. The fire resistant barrier of claim 13 wherein the two folded layers of aerogel are configured to unfold when the intumescent layer expands under the influence of heat.

15. The fire resistant barrier of claim 13 further comprising another layer of intumescent encapsulated by the two layers of aerogel.
